(19) United States
(12) Patent Application Publication
(10) Pub. No.: US 2015/0221168 A1
(43) Pub. Date: Aug. 6, 2015

(54) GAMING SYSTEM AND METHOD FOR CONVERTING AWARDS TO FREE GAMES AND FREE GAME OPPORTUNITIES

(71) Applicant: IGT, Las Vegas, NV (US)

(72) Inventors: George E. Spark-Stahl, Reno, NV (US); Bryan D. Wolf, Reno, NV (US); Corey Nakamura, Sparks, NV (US); Dorothy P. Cheung, Reno, NV (US)

(21) Appl. No.: 14/169,688

(22) Filed: Jan. 31, 2014

(51) Int. Cl. G07F 17/32

(52) U.S. Cl. CPC G07F 17/3244

(57) ABSTRACT

A gaming system which converts one or more primary game awards to one or more free games and/or one or more opportunities to be provided one or more free games. The quantity of free games provided and the probability of successfully obtaining a free game in association with a free game opportunity are each based on the primary game award and an average expected value associated with each free game.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. Gaming machines generally require the player to place or make a wager to activate the primary or base game. In many of these gaming machines, the award is based on the player obtaining a winning symbol or symbol combination and on the amount of the wager (e.g., the higher the wager, the higher the award).

Gaming machines which provide secondary or bonus games are also known. The secondary or bonus games usually provide an additional award, such as a bonus award, to the player. Secondary or bonus games usually do not require an additional wager by the player to be activated. Instead, secondary or bonus games are generally activated or triggered upon an occurrence of a designated triggering symbol or triggering symbol combination in the primary or base game. When a secondary or bonus game is triggered, the gaming machine generally indicates this triggering to the player through one or more visual and/or audio output devices, such as the reels, lights, speakers, video screens, etc. Part of the enjoyment and excitement of playing certain gaming machines is the occurrence or triggering of the secondary or bonus game (even before the player knows how much the bonus award will be).

One such type of secondary or bonus game includes a free spin mode or sequence. In these gaming machines, when the secondary or bonus game is triggered, the gaming machine temporarily halts the primary game play and enables a player to enter a free spin mode or sequence wherein one or more free spins or free games are provided to the player. The player plays the free spin mode or sequence, likely receives an award during one or more of the free spins or free games and returns to the primary game. Free spin modes or sequences that provide players with large awards or the potential to win large awards are attractive to players.

There is a continuing need to increase the level of excitement and entertainment for people playing gaming machines. There is a further need for increasing the number of winning symbol combinations generated and awards provided to a player for a single wager on a play of a game, such as by enabling a player to participate in a free spin mode or sequence.

### SUMMARY

The present disclosure relates generally to gaming systems and methods for converting awards to free games and free game opportunities.

In various embodiments, the gaming system disclosed herein converts part or all of one or more primary game awards to one or more free games and/or one or more opportunities to be provided one or more free games. In these embodiments, rather than providing a player a primary game award associated with a determined primary game outcome, the gaming system provides part or none of the primary game award to the player and converts part or all of the primary game award to a quantity of free games and/or a quantity of free game opportunities. In these embodiments, the quantity of free games provided and the probability of successfully obtaining a free game in association with a free game opportunity are each based on the primary game award and an average expected value associated with each free game, such that an average expected value of the free games or free game opportunities is equal to, substantially equal to or otherwise within a designated range of the value of the converted portion of the primary game award. Accordingly, the gaming system of the present disclosure converts, modifies or transforms a static value of part or all of a primary game award to a dynamic or variable value award by enabling the player to participate in one or more free games and/or one or more free game opportunities (which may result in one or more free games). Such a configuration provides an increased level of excitement and enjoyment for certain players because these players enjoy the increased volatility and potentially increased awards associated with playing a quantity of free games in lieu of being provided a determined primary game award.

More specifically, in operation of various embodiments, the gaming system enables a player to play a primary game. In association with the play of the primary game, the gaming system determines and displays a primary game outcome. The gaming system then determines and display any primary game award associated with the determined primary game outcome. In these embodiments, rather than providing the player any primary game award associated with the determined primary game outcome, the gaming system provides part or none of the primary game award to the player and determines whether to convert part or all of any primary game award to any free games. In certain embodiments, this determination is based, at least in part, on a comparison of the determined primary game award to an average expected value associated with each free game. In one such embodiment, the determination of whether to convert part or all of any primary game award to a quantity of free games is based on whether the determined primary game award is greater than the average expected value of the free game. For example, if a free game has an average expected value of twenty credits and the primary game award is forty credits, the gaming system converts all of this forty credit primary game award into two free games (having a total average expected value of forty credits).

If the gaming system converts part or all of any primary game award to one or more free games, for each provided free game, the gaming system determines and displays a free game outcome. For each free game, the gaming system then determines, displays and provides to the player any free game award associated with the determined free game outcome. Continuing with the above example in which the gaming system converted a primary game award of forty credits into two free games: (i) for the first free game, the gaming system determined and displayed a first free game outcome associated with a first free game award of fifteen credits, and (ii) for the second free game, the gaming system determined and displayed a second free game outcome associated with a second free game award of thirty-five credits. In this example, the gaming system provided the player the two free game awards totaling fifty credits and returned to the primary game to await another play of the primary game. It should be appreciated that as illustrated in this example, the conversion of the primary game award to a plurality of free games netted the player a total free game award greater than the primary game award and thus such a conversion resulted in an additional benefit provided to the player.

If the gaming system determined not to convert part or all of any primary game award to any free games (e.g., the primary game award is less than the average expected value of each free game), the gaming system determines the parameters of a free game opportunity to convert part or all of the primary game award into. Each free game opportunity includes the gaming system randomly determining whether to provide the player zero, one or more free games, wherein the random determination is based, at least in part, on the determined primary game award and the average expected value associated with each free game. That is, based on a comparison of the determined primary game award to the average expected value associated with each free game, the gaming system determines a probability of successfully obtaining a free game in association with the free game opportunity. For example, if a free game has an average expected value of twenty credits and the primary game award is fifteen credits, the gaming system converts this fifteen credit primary game award into a free game opportunity having a 75% of obtaining a free game.

Following the determination of the parameters of the free game opportunity, the gaming system displays a free game opportunity including a determination whether to provide the player one or more free games, wherein such a determination is based on the determined free game opportunity parameters. Continuing with the above example in which the gaming system converted a primary game award of fifteen credits into a free game opportunity with a 75% chance of successfully obtaining a free game, the gaming system determined that the free game opportunity resulted in providing the player one free game.

If the free game opportunity resulted in no free games, the gaming system returns to the primary game and awaits another play of the primary game. On the other hand, if the free game opportunity results in providing the player one or more free games, for each provided free game, the gaming system determines and displays a free game outcome. For each free game, the gaming system then determines, displays and provides to the player any free game award associated with the determined free game outcome. Continuing with the above example in which the gaming system converted a primary game award of fifteen credits into a free game opportunity (with a 75% success probability) which resulted in providing the player one free game, for this free game, the gaming system determined and displayed a free game outcome associated with a free game award of twenty-five credits. In this example, the gaming system provided the player the free game award of twenty-five credits and returned to the primary game to await another play of the primary game. As illustrated in this example, the free game award of twenty-five credits is greater than the primary game award of fifteen credits which the player would have been provided absent this free game opportunity conversion.

Accordingly, the gaming system of the present disclosure determines a primary game award and then determines, accounting for the primary game award and the average expected value of each free game, whether to convert such a primary game award to zero, one or more free games, and zero, one or more free game opportunities, wherein: (i) each free game opportunity represents a chance (based on the primary game award and the average expected value of each free game) to obtain one or more free games; and (ii) each free game represents a chance to win a different award than the determined primary game award. Such a configuration increases the number of random determinations utilized to determine the player's award which provides an increased level of anticipation for certain players and thus an increased gaming experience for such players. Such a configuration of converting primary game awards to zero, one or more free games further provides the player one or more additional award opportunities in association with one play of a game.

Additional features and advantages are described herein, and will be apparent from the following Detailed Description and the figures.

### BRIEF DESCRIPTION OF THE FIGURES

FIG. 1 is a flow chart an example process for operating a gaming system including converting a primary game award to zero, one or more free games and zero, one or more free game opportunities as disclosed herein.

FIG. 2 is an example conversion table of one embodiment of the gaming system disclosed herein illustrating the conversion rate of primary game awards to free games and free game opportunities.

FIG. 3A is a schematic block diagram of one embodiment of a network configuration of the gaming system disclosed herein.

FIG. 3B is a schematic block diagram of one embodiment of an electronic configuration of the gaming system disclosed herein.

FIGS. 4A and 4B are perspective views of example alternative embodiments of the gaming system disclosed herein.

### DETAILED DESCRIPTION

### Converting Primary Game Awards to Free Games

In various embodiments, the gaming system disclosed herein converts part or all of one or more primary game awards to one or more free games and/or one or more opportunities to be provided one or more free games. In these embodiments, rather than providing a player a primary game award associated with a determined primary game outcome, the gaming system provides part or none of the primary game award to the player and converts part or all of the primary game award to a quantity of free games and/or a quantity of free game opportunities. In these embodiments, the quantity of free games provided and the probability of successfully obtaining a free game in association with a free game opportunity are each based on the primary game award and an average expected value associated with each free game. Accordingly, the gaming system of the present disclosure converts, modifies or transforms a static value of part or all of a primary game award to a dynamic or variable value award by enabling the player to participate in one or more free games and/or one or more free game opportunities (which may result in one or more free games). Such a configuration provides an increased level of excitement and enjoyment for certain players because these players enjoy the increased volatility and potentially increased awards associated with playing a quantity of free games in lieu of being provided a determined primary game award.

While certain of the embodiments described below are directed to converting a primary game award to a quantity of free games and/or a quantity of free game opportunities, it should be appreciated that the present disclosure may additionally or alternatively be employed in association with converting a secondary or bonus game award to a quantity of free games and/or a quantity of free game opportunities. Moreover, while the player's credit balance, the player's wager, and any awards are displayed as an amount of monetary credits or currency in the embodiments described below, one or more of such player's credit balance, such player's wager, and any awards provided to such player may be for non-monetary credits, promotional credits, and/or player tracking points or credits.

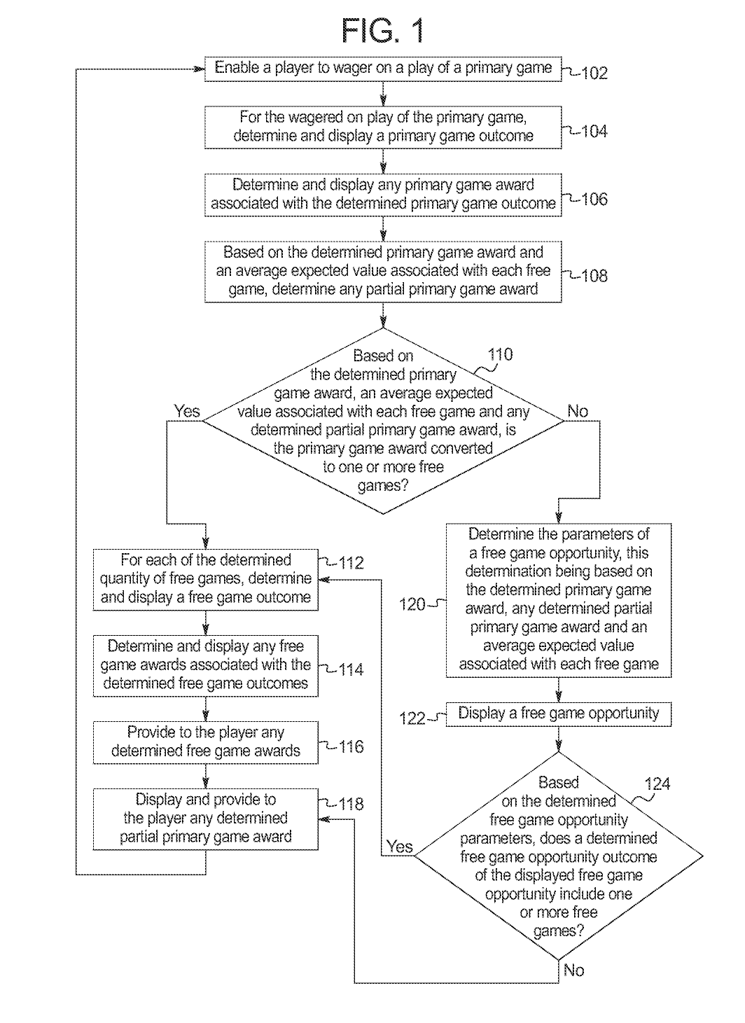

Referring now to FIG. 1, a flowchart of an example embodiment of a process for operating a gaming system disclosed herein is illustrated. In one embodiment, this process is embodied in one or more software programs stored in one or more memories and executed by one or more processors or servers. Although this process is described with reference to the flowchart illustrated in FIG. 1, it should be appreciated that many other methods of performing the acts associated with this process may be used. For example, the order of certain steps described may be changed, or certain steps described may be optional.

In one embodiment, as indicated in block 102, the gaming system enables a player to wager on a play of a primary game. For the wagered on play of the primary game, as indicated in block 104, the gaming system determines and displays a primary game outcome, such as a primary game symbol combination. As indicated in block 106, the gaming system further determines and displays any primary game award associated with the determined primary game outcome.

Following the display of any primary game award associated with the determined primary game outcome, as indicated in block 108, the gaming system determines any partial primary game award, wherein this determination is based on the determined primary game award and an average expected value associated with each free game. The gaming system then determines, as indicated in diamond 110, if part or all of the primary game award is converted to one or more free games, wherein this determination is based on the determined primary game award, an average expected value associated with each free game and any determined partial primary game award. That is, the gaming system accounts for both the determined primary game award and an average expected value of each free game in determining: (i) part, all or none of the primary game award to provide to the player, and (ii) zero, one or more free games to provide to the player. Put differently, the gaming system determines whether to convert part or all of the primary game award to a quantity of free games wherein the conversion is based, at least in part, on the determined primary game award and an average expected value associated with each free game.

In one embodiment, the determination of whether to convert the primary game award to one or more free games is based on a comparison of the primary game award (minus any determined partial primary game award) to the average expected value of a free game. In this embodiment, the gaming system determines if the primary game award (minus any determined partial primary game award) is greater than the average expected value of the free game, wherein any primary game award greater than the average expected value of the free game results in one or more free games in lieu of part or all of the primary game award. One such embodiment includes the gaming system comparing the primary game award to the cost of a game. For example, if a game costs forty credits to play, then the gaming system converts a forty credit win to a free game. In another example, if the average expected value of a free game is forty credits, but a play of the game costs forty-five credits, the gaming system converts a forty-five credit win to a free game. In this embodiment, a free game simulates the play of two games, wherein the player took their winnings from one game and wagered them on another game.

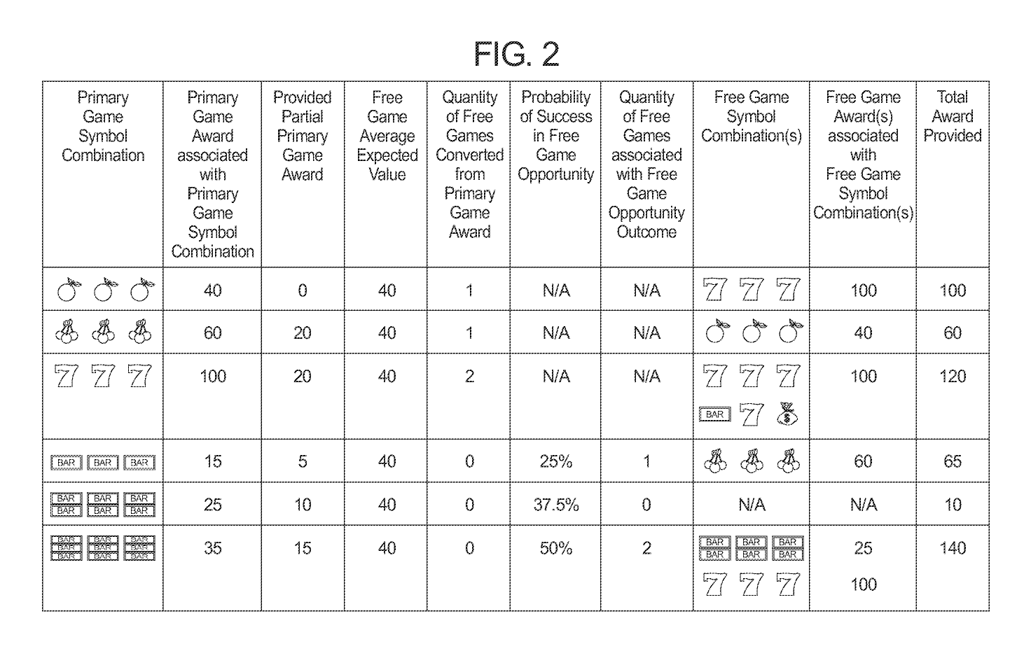

For example, as seen in FIG. 2, if a free game has an average expected value of forty credits and the gaming system randomly generates a primary game outcome of orange symbol-orange symbol-orange symbol associated with a primary game award of forty credits, the gaming system determines, based on the primary game award equaling the average expected value of the free game, to convert the determined primary game award of forty credits to one free spin. In another example, as also seen in FIG. 2, if a free game has an average expected value of forty credits and the gaming system randomly generates a primary game outcome of cherry symbol-cherry symbol-cherry symbol associated with a primary game award of sixty credits, the gaming system determines, based on the primary game award being greater than the average expected value of the free game by twenty credit, to convert the determined primary game award of sixty credits to one free spin and a partial primary game award of twenty credits to provide to the player. In another example, as further seen in FIG. 2, if a free game has an average expected value of forty credits and the gaming system randomly generates a primary game outcome of seven symbol-seven symbol-seven symbol associated with a primary game award of one-hundred credits, the gaming system determines, based on the primary game award being greater than two times the average expected value of the free game by twenty credit, to convert the determined primary game award of one-hundred credits to two free spins and a partial primary game award of twenty credits to provide to the player.

Following the determination of any partial primary game award and a quantity of any free games to provide to the player, if the gaming system determined to convert the determined primary game award to at least one free game, for each of the determined quantity of free games, as indicated in block 112, the gaming system determines and displays a free game outcome, such as a free game symbol combination. As indicated in block 114, the gaming system further determines and displays, for each of the determined quantity of free games, any free game award associated with the determined free game outcome. Following the determination of any free game awards, the gaming system provides to the player, as indicated in block 116, any determined free game awards. The gaming system then displays and provides to the player any determined partial primary game award as indicated in block 118 and returns to block 102 to await another wager on another play of the primary game.

For example, as seen in FIG. 2, if the gaming system determined to convert the primary game outcome of orange symbol-orange symbol-orange symbol (associated with a primary game award of forty credits) to one free game (having an average expected value of forty credits) and the gaming system randomly generated a free game outcome of seven symbol-seven symbol-seven symbol (associated with a free game award of one-hundred credits), the gaming system provides the player the free game award of one-hundred credits (instead of the primary game award of forty credits). As seen in this example, the determination to convert the player's primary game award to a free spin resulted in a greater award for the player (and thus a more favorable gaming experience for the player).

In another example, as seen in FIG. 2, if the gaming system determined to convert the primary game outcome of cherry symbol-cherry symbol-cherry symbol (associated with a primary game award of sixty credits) to one free game (having an average expected value of forty credits) and a partial primary game award of twenty credits, and the gaming system randomly generated a free game outcome of orange symbol-orange symbol-orange symbol (associated with a free game award of forty credits), the gaming system provides the player the free game award of forty credits (instead of the primary game award of sixty credits). As seen in this example, when accounting for the determined partial primary game award, the determination to convert the player's primary game award to a free spin resulted in the same total award for the player.

On the other hand, if the gaming system determined not to convert the determined primary game award to at least one free game, the gaming system determines the parameters of a free game opportunity as indicated in block 120. As further indicated in block 120, this determination is based on the determined primary game award, any determined partial primary game award and an average expected value associated with each free game. In these embodiments, each free game opportunity includes the gaming system determining whether to provide the player zero, one or more free games, wherein the determination is based, at least in part, on the determined primary game award, any determined partial primary game award and the average expected value associated with each free game. More specifically, each free game opportunity includes the gaming system determining whether to provide the player zero, one or more free games, wherein the probability of successfully obtaining one or more free games in association with the free game opportunity is based, at least in part, on the determined primary game award, any determined partial primary game award and the average expected value associated with each free game

In one embodiment, the determination of the parameters of the free game opportunity is based on a comparison of the primary game award (minus any determined partial primary game award) to the average expected value of a free game. In this embodiment, if the gaming system determines that the primary game award is less than the average expected value of the free game, the gaming system determines a probability of successfully obtaining one or more free games in the free game opportunity based on a ratio of the primary game award (accounting for any determined partial primary game awards) to the average expected value of the free game.

For example, as seen in FIG. 2, if a free game has an average expected value of forty credits, the gaming system randomly generates a primary game outcome of single bar symbol-single bar symbol-single bar symbol associated with a primary game award of fifteen credits and the gaming system determined a partial primary game award of five credits to provide to the player, the gaming system determines, based on the remaining primary game award of ten credits (i.e., the primary game award of fifteen credits minus the determined partial primary game award of five credits) being 25% of the free game average expected value of forty credits, a 25% probability (or 10 credits of the remaining primary game award/40 credits of the free game average expected value) of successfully obtaining one or more free games in a free game opportunity.

In another example, as also seen in FIG. 2, if a free game has an average expected value of forty credits, the gaming system randomly generates a primary game outcome of double bar symbol-double bar symbol-double bar symbol associated with a primary game award of twenty-five credits and the gaming system determined a partial primary game award of ten credits to provide to the player, the gaming system determines, based on the remaining primary game award of fifteen credits (i.e., the primary game award of twenty-five credits minus the determined partial primary game award of ten credits) being 37.5% of the free game average expected value of forty credits, a 37.5% probability (or fifteen credits of the remaining primary game award/40 credits of the free game average expected value) of successfully obtaining one or more free games in a free game opportunity.

In another example, as further seen in FIG. 2, if a free game has an average expected value of forty credits, the gaming system randomly generates a primary game outcome of triple bar symbol-triple bar symbol-triple bar symbol associated with a primary game award of thirty-five credits and the gaming system determined a partial primary game award of fifteen credits to provide to the player, the gaming system determines, based on the remaining primary game award of twenty credits (i.e., the primary game award of thirty-five credits minus the determined partial primary game award of fifteen credits) being 50% of the free game average expected value of forty credits, a 50% probability (or twenty credits of the remaining primary game award/40 credits of the free game average expected value) of successfully obtaining one or more free games in a free game opportunity.

Following the determination of the parameters of the free game opportunity, as indicated in block 122 of FIG. 1, the gaming system displays a free game opportunity. For the displayed free game opportunity, as indicated in diamond 124, the gaming system determines, based on the determined free game opportunity parameters, whether a determined free game opportunity outcome includes one or more free games.

In one such embodiment, wherein the gaming system determines a probability of successfully obtaining one or more free games in the free game opportunity based on a ratio of the primary game award (accounting for any determined partial primary game awards) to the average expected value of the free game, the gaming system determines, based on the determined probability, whether to provide the player one or more free games.

For example, as seen in FIG. 2, if the gaming system determined that, after accounting for the determined partial primary game award of five credits, the primary game outcome of single bar symbol-single bar symbol-single bar symbol (associated with a primary game award of fifteen credits) has a 25% probability of successfully obtaining one or more free games in a free game opportunity, the gaming system displays the free game opportunity and determines a free game opportunity outcome of the player successfully obtaining one free game in the displayed free game opportunity.

In another example, as also seen in FIG. 2, if the gaming system determined that, after accounting for the determined partial primary game award of ten credits, the primary game outcome of double bar symbol-double bar symbol-double bar symbol (associated with a primary game award of twenty-five credits) has a 37.5% probability of successfully obtaining one or more free games in a free game opportunity, the gaming system displays the free game opportunity and determines a free game opportunity outcome of the player not obtaining any free games in the displayed free game opportunity.

In another example, as further seen in FIG. 2, if the gaming system determined that, after accounting for the determined partial primary game award of fifteen credits, the primary game outcome of triple bar symbol-triple bar symbol-triple bar symbol (associated with a primary game award of thirty-five credits) has a 50% probability of successfully obtaining one or more free games in a free game opportunity, the gaming system displays the free game opportunity and determines a free game opportunity outcome of the player successfully obtaining two free games in the displayed free game opportunity.

In another embodiment, the gaming system employs one or more secondary games to determine a quantity of free games, if any, to provide the player in association with a free game opportunity. In one such embodiment, a secondary game includes a free game generator, such as a wheel, with different sections or slices associated with different quantities of free games. For example, if the gaming system determines that a free game opportunity has a 50% probability of success and the gaming system displays a free game opportunity as a play of a wheel game, the gaming system associates 50% of the slices of the wheel with a free game and 50% of the slices of the wheel without a free game. In another such embodiment, a secondary game includes a plurality of selections associated with different quantities of free games. For example, if the gaming system determines that a free game opportunity has a 75% probability of success and the gaming system displays a free game opportunity as a play of a selection game, the gaming system associates 75% of the available selections with a free game and 25% of the available selections without a free game. It should be appreciated that any suitable secondary game may be employed in association with determining a quantity of free games in association with a free game opportunity.

In different embodiments, one or more free game opportunities include, but are not limited to:
i. a play of any suitable slot game;
ii. a play of any suitable free spins or free game activations;
iii. a play of any suitable wheel game;
iv. a play of any suitable card game;
v. a play of any suitable offer and acceptance game;
vi. a play of any suitable award ladder game;
vii. a play of any suitable puzzle-type game;
viii. a play of any suitable persistence game;
ix. a play of any suitable selection game;
x. a play of any suitable cascading symbols game;
xi. a play of any suitable ways to win game;
xii. a play of any suitable scatter pay game;
xiii. a play of any suitable coin-pusher game;
xiv. a play of any suitable elimination game;
xv. a play of any suitable stacked wilds game;
xvi. a play of any suitable trail game;
xvii. a play of any suitable bingo game;
xviii. a play of any suitable video scratch-off game;
xix. a play of any suitable pick-until-complete game;
xx. a play of any suitable shooting simulation game;
xxi. a play of any suitable racing game;
xxii. a play of any suitable promotional game;
xxiii. a play of any suitable high-low game;
xxiv. a play of any suitable lottery game;
xxv. a play of any suitable number selection game;
xxvi. a play of any suitable dice game;
xxvii. a play of any suitable skill game;
xxviii. a play of any suitable auction game;
xxix. a play of any suitable reverse-auction game;
xxx. a play of any suitable group game;
xxxi. a play of any suitable game in a service window;
xxxii. a play of any suitable game on a mobile device; and/or
xxxiii. a play of any suitable game disclosed herein;

In one embodiment, the gaming system utilizes a weighted table to determine a quantity of free games, if any, to provide the player in association with a free game opportunity. In this embodiment, after determining a probability of success of obtaining one or more free games, the gaming system accesses a weighted table having an average expected quantity of free games equal (or substantially equal, such as having an average expected quantity of free games within a predefined range of average expected quantities of free games) to the average expected quantity of free games of the free game opportunity (with the determined probability of success). For example, if the gaming system determines a 75% probability of obtaining a free game in a free game opportunity, the gaming system utilizes weighted table #1 (reproduced below) to determine the quantity of free games, if any, to provide to the player in the free game opportunity:

TABLE #1

| Free Spins | Weight |
|---|---|
| 0 | 22 |
| 1 | 6 |
| 2 | 4 |
| 3 | 3 |
| 4 | 1 |

Referring back to FIG. 1, if the determined free game opportunity outcome results in no free games, the gaming system displays and provides to the player any determined partial primary game award as indicated in block 118 and returns to block 102 to await another wager on another play of the primary game.

On the other hand, if the determined free game opportunity outcome results in at least one free game, the gaming system returns to block 112 and for each of the determined quantity of free games, the gaming system determines and displays a free game outcome, such as a free game symbol combination. As indicated in block 114, the gaming system further determines and displays, for each of the determined quantity of free games, any free game award associated with the determined free game outcome. Following the determination of any free game awards, the gaming system provides to the player, as indicated in block 116, the determined free game awards. The gaming system then displays and provides to the player any determined partial primary game award as indicated in block 118 and returns to block 102 to await another wager on another play of the primary game.

For example, as seen in FIG. 2, if the gaming system determined that the free game opportunity outcome associated with the primary game outcome of single bar symbol-single bar symbol-single bar symbol resulted in one free game, the gaming system randomly generated a free game outcome of cherry symbol-cherry symbol-cherry symbol (associated with a free game award of sixty credits. As seen in this example, when accounting for the determined partial primary game award of five credits, the determination to convert the player's primary game award to a free game opportunity resulted in a total award of sixty-five credits (which is greater than the primary game award of fifteen credits associated with the single bar symbol-single bar symbol-single bar symbol primary game outcome). Accordingly, the determination to convert the player's primary game award to a free game (via a free game opportunity) resulted in a greater award for the player (and thus a more favorable gaming experience for the player).

In another example, as also seen in FIG. 2, if the gaming system determined that the free game opportunity outcome associated with the primary game outcome of triple bar symbol-triple bar symbol-triple bar symbol resulted in two free games, the gaming system randomly generated: (i) a first free game outcome of double bar symbol-double bar symbol-double bar symbol (associated with a free game award of twenty-five credits), and (ii) a second free game outcome of seven symbol-seven symbol-seven symbol (associated with a free game award of one-hundred credits). As seen in this example, when accounting for the determined partial primary game award of fifteen credits, the determination to convert the player's primary game award to a free game opportunity resulted in a total award of one-hundred-forty credits (which is greater than the primary game award of thirty-five credits associated with the triple bar symbol-triple bar symbol-triple bar symbol primary game outcome). Accordingly, this determination to convert the player's primary game award to two free games (via a free game opportunity) also resulted in a greater award for the player (and thus a more favorable gaming experience for the player).

Accordingly, the gaming system of the present disclosure determines a primary game award and then determines, accounting for the primary game award and the average expected value of each free game, whether to convert such a primary game award to zero, one or more free games, and zero, one or more free game opportunities, wherein: (i) each free game opportunity represents a chance (based on the primary game award and the average expected value of each free game) to obtain one or more free games and (ii) each free game represents a chance to win a different award than the determined primary game award. Such a configuration increases the number of random determinations utilized to determine the player's award which provides an increased level of anticipation for certain players and thus an increased gaming experience for such players. Such a configuration of converting primary game awards to zero, one or more free games further provides the player one or more additional award opportunities in association with one play of a game.

In one embodiment, the gaming system utilizes different free game opportunities for different plays of the primary game. In another embodiment, the gaming system utilizes different free game opportunities for different primary game outcomes. In another embodiment, the gaming system utilizes different free game opportunities for different primary game award amounts. In another embodiment, the gaming system utilizes the same free game opportunity for different plays of the primary game. In another embodiment, the gaming system utilizes the same free game opportunity for different primary game outcomes. In another embodiment, the gaming system utilizes the same free game opportunity for different primary game award amounts. In another embodiment, rather than displaying to the player the free game opportunity, the gaming system determines a free game opportunity outcome and informs the player regarding a quantity of free games, if any, provided.

In one embodiment, as described above, the gaming system determines whether to convert each individual primary game award into a quantity of free games and/or one or more free game opportunities. In another embodiment, the gaming system groups a plurality of primary game awards together and determines whether to convert the collective primary game awards into a quantity of free games and/or one or more free game opportunities. That is, if the gaming system determines that a plurality of primary game awards are associated with the generated symbols on a plurality of paylines, the gaming system groups the primary game awards into a single determination of whether to convert the collective primary game awards into a quantity of free games and/or one or more free game opportunities.

For example, if the gaming system determines to convert: (i) one primary game award into one determination having a 25% probability of obtaining a free game in a free game opportunity, and (ii) another primary game award into another determination having a 50% probability of obtaining a free game in a free game opportunity, the gaming system combines these separate determinations into a single determination having a 75% probability of obtaining a free game in a free game opportunity.

In one embodiment, if the gaming system combines a plurality of different probabilities and the total is more than a 100% probability of obtaining one or more free game, the gaming system determines the parameters of the free game opportunity to account for different quantities of free games. For example, if the gaming system displays the free game opportunity to the player as a spin of a free game wheel and the gaming system determines to convert three primary game awards (each having a 50% probability of obtaining a free game in a free game opportunity) into a single determination, the gaming system associates: (i) 50% of the sections of the free game wheel with a quantity of one free game, and (ii) 50% of the sections of the free game wheel with a quantity of two free games.

In another example wherein the gaming system displays the free game opportunity to the player as a spin of a free game wheel and the gaming system determines to convert: (i) one primary game award into one determination having a 25% probability of obtaining a free game in a free game opportunity, and (ii) another primary game award into another determination having a 50% probability of obtaining a free game in a free game opportunity into a single determination, the gaming system associates: (i) 50% of the sections of the free game wheel with a quantity of one free game, (ii) 12.5% of the sections of the free game wheel with a quantity of two free games, and (iii) 37.5% of the sections of the free game wheel with a quantity of zero free games. It should be appreciated that in one embodiment, regardless of if the gaming system combines primary game awards into a total primary game award (for a single determination) or accounts for each primary game award separately (resulting in a plurality of determinations), the probability of obtaining one or more free games in the free game opportunity remain the same (or substantially the same, such as within a predefined ranges of probabilities).

In one embodiment, as described above, the gaming system determines any partial primary game award and provides that partial primary game award to the player. In another embodiment, rather than providing the partial primary game award to the player, the gaming system determines the parameters of a free game opportunity wherein the determination is based on the determined partial primary game award and an average expected value associated with each free game. For example, if a free game has an average expected value of forty credits and the gaming system determined a partial primary game award of ten credits, the gaming system determines, based on the partial primary game award of ten credits being 25% of the free game average expected value of forty credits, a 25% probability (or ten credits of the partial primary game award/40 credits of the free game average expected value) of successfully obtaining one or more free games in a free game opportunity.

In another embodiment, rather than providing the player any partial primary game award, the gaming system contributes this partial primary game award to a free game progressive pool. In this embodiment, if the partial primary game award is less than the average expected value of a free game, the gaming system contributes a partial or fractional free game to the free game progressive pool. In this embodiment, if a free game progressive award triggering event occurs, the gaming system provides part or all of the accumulated quantity of free games to one or more players.

In one embodiment, the gaming system utilizes one or more of the same wager amounts, the same symbols, the same symbol combinations, the same probabilities of one or more symbols being generated, the same awards and/or the same paytable in the primary game and one or more free games. In another embodiment, the gaming system utilizes one or more of different wager amounts, different symbols, different symbol combinations, different probabilities of one or more symbols being generated, different awards and/or different paytables in the primary game and one or more free games.

In different embodiments, one or more awards provided in association with one or more primary game plays, one or more free game plays, and/or one or more secondary game plays include, but are not limited to, one or more of: a quantity of monetary credits, a quantity of non-monetary credits, a quantity of promotional credits, a quantity of player tracking points, a progressive award, a modifier, such as a multiplier, a quantity of free plays of one or more games, a quantity of plays of one or more secondary or bonus games, a multiplier of a quantity of free plays of a game, one or more lottery based awards, such as lottery or drawing tickets, a wager match for one or more plays of one or more games, an increase in the average expected payback percentage for one or more plays of one or more games, one or more comps, such as a free dinner, a free night's stay at a hotel, a high value product such as a free car, or a low value product such as a free teddy bear, one or more bonus credits usable for online play, a lump sum of player tracking points or credits, a multiplier for player tracking points or credits, an increase in a membership or player tracking level, one or more coupons or promotions usable within and/or outside of the gaming establishment (e.g., a 20% off coupon for use at a convenience store), virtual goods associated with the gaming system, virtual goods not associated with the gaming system, an access code usable to unlock content on an internet.

In one embodiment, the gaming system causes at least one display device of at least one electronic gaming machine to display any free game conversions, any free games and/or any free game opportunities. In another embodiment, in addition or in alternative to each electronic gaming machine displaying any free game conversions, any free games and/or any free game opportunities, the gaming system causes one or more community or overhead display devices to display part or all of any free game conversions, any free games and/or any free game opportunities to one or more other players or bystanders either at a gaming establishment or viewing over a network, such as the internet. In another embodiment, in addition or in alternative to each electronic gaming machine displaying any free game conversions, any free games and/or any free game opportunities, the gaming system causes one or more internet sites to each display any free game conversions, any free games and/or any free game opportunities such that a player is enabled to log on from a personal web browser. In another such embodiment, the gaming system enables the player to play one or more games on one device while viewing any free game conversions, any free games and/or any free game opportunities from another device, such as a desktop or laptop computer.

In one embodiment, the gaming system determines whether or not to activate the free game conversion feature disclosed herein based on if the primary game award is greater than or equal to a designated value. In another embodiment, the gaming system determines whether or not to activate the free game conversion feature disclosed herein based on a player's selection to opt in or opt out of such a feature. In another embodiment, the gaming system determines whether or not to activate the free game conversion feature disclosed herein based on whether or not a free game conversion triggering event occurs.

In one embodiment, the gaming system determines whether or not to activate the free game opportunity feature disclosed herein based on if the primary game award is greater than or equal to a designated value. In another embodiment, the gaming system determines whether or not to activate the free game opportunity feature disclosed herein based on a player's selection to opt in or opt out of such a feature. In another embodiment, the gaming system determines whether or not to activate the free game opportunity feature disclosed herein based on whether or not a free game opportunity triggering event occurs.

In another embodiment, as described above, rather than providing any partial primary game awards, the gaming system contributes such partial primary game awards to a free game progressive award, wherein the gaming system determines whether to activate the free game progressive award feature and/or provide such a free game progressive award to one or more players based on if the primary game award is greater than or equal to a designated value. In another embodiment, the gaming system determines whether to activate the free game progressive award feature and/or provide such a free game progressive award to one or more players based on whether or not a free game progressive award triggering event occurs. In another embodiment, the gaming system determines whether to activate the free game progressive award feature based on a player's selection to opt in or opt out of such a feature.

In different embodiments, a free game conversion triggering event, a free game opportunity triggering event and/or a free game progressive award triggering event occurs based on an outcome associated with one or more plays of any primary games. In one embodiment, such determinations are symbol driven based on the generation of one or more designated symbols or symbol combinations. In various embodiments, a generation of a designated symbol (or sub-symbol) or a designated set of symbols (or sub-symbols) over one or more plays of a primary game causes such conditions to be satisfied and/or one or more of such events to occur.

In different embodiments, the gaming system does not provide any apparent reasons to the players for an occurrence of a free game conversion triggering event, a free game opportunity triggering event and/or a free game progressive award triggering event. In these embodiments, such determinations are not triggered by an event in a primary game or based specifically on any of the plays of any primary games. That is, these events occur without any explanation or alternatively with simple explanations.

In one such embodiment, a free game conversion triggering event, a free game opportunity triggering event and/or a free game progressive award triggering event occurs based on an amount of coin-in. In this embodiment, the gaming system determines if an amount of coin-in reaches or exceeds a designated amount of coin-in (i.e., a threshold coin-in amount). Upon the amount of coin-in wagered reaching or exceeding the threshold coin-in amount, the gaming system causes one or more of such events or conditions to occur. In another such embodiment, a free game conversion triggering event, a free game opportunity triggering event and/or a free game progressive award triggering event occurs based on an amount of virtual currency-in. In this embodiment, the gaming system determines if an amount of virtual currency-in wagered reaches or exceeds a designated amount of virtual currency-in (i.e., a threshold virtual currency-in amount). Upon the amount of virtual currency-in wagered reaching or exceeding the threshold virtual currency-in amount, the gaming system causes one or more of such events or conditions to occur. In different embodiments, the threshold coin-in amount and/or the threshold virtual currency-in amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In one such embodiment, a free game conversion triggering event, a free game opportunity triggering event and/or a free game progressive award triggering event occurs based on an amount of coin-out. In this embodiment, the gaming system determines if an amount of coin-out reaches or exceeds a designated amount of coin-out (i.e., a threshold coin-out amount). Upon the amount of coin-out reaching or exceeding the threshold coin-out amount, the gaming system causes one or more of such events or conditions to occur. In another such embodiment, a free game conversion triggering event, a free game opportunity triggering event and/or a free game progressive award triggering event occurs based on an amount of virtual currency-out. In this embodiment, the gaming system determines if an amount of virtual currency-out reaches or exceeds a designated amount of virtual currency-out (i.e., a threshold virtual currency-out amount). Upon the amount of virtual currency-out reaching or exceeding the threshold virtual currency-out amount, the gaming system causes one or more of such events or conditions to occur. In different embodiments, the threshold coin-out amount and/or the threshold virtual currency-out amount is predetermined, randomly determined, determined based on a player's status (such as determined through a player tracking system), determined based on a generated symbol or symbol combination, determined based on a random determination by the central controller, determined based on a random determination at the gaming device, determined based on one or more side wagers placed, determined based on the player's primary game wager, determined based on time (such as the time of day) or determined based on any other suitable method or criteria.

In different embodiments, a free game conversion triggering event, a free game opportunity triggering event and/or a free game progressive award triggering event occurs based on a predefined variable reaching a defined parameter threshold. For example, when the 500,000^{th} player has played an electronic gaming machine (ascertained from a player tracking system), one or more of such events or conditions occur. In different embodiments, the predefined parameter thresholds include a length of time, a length of time after a certain dollar amount is hit, a wager level threshold for a specific device (which electronic gaming machine is the first to contribute $250,000), a number of electronic gaming machines active, or any other parameter that defines a suitable threshold.

In different embodiments, a free game conversion triggering event, a free game opportunity triggering event and/or a free game progressive award triggering event occurs based on a quantity of games played. In this embodiment, a quantity of games played is set for when one or more of such events or conditions will occur. In one embodiment, such a set quantity of games played is based on historic data.

In different embodiments, a free game conversion triggering event, a free game opportunity triggering event and/or a free game progressive award triggering event occurs based on time. In this embodiment, a time is set for when one or more of such events or conditions will occur. In one embodiment, such a set time is based on historic data.

In different embodiments, a free game conversion triggering event, a free game opportunity triggering event and/or a free game progressive award triggering event occurs based upon gaming system operator defined player eligibility parameters stored on a player tracking system (such as via player tracking card or other suitable manner). In this embodiment, the parameters for eligibility are defined by the gaming system operator based on any suitable criterion. In one embodiment, the gaming system recognizes the player's identification (via the player tracking system) when the player inserts or otherwise associates their player tracking card in the electronic gaming machine. The gaming system determines the player tracking level of the player and if the current player tracking level defined by the gaming system operator is eligible for one or more of such events or conditions. In one embodiment, the gaming system operator defines minimum bet levels required for such events or conditions to occur based on the player's card level. In other embodiments, a free game conversion triggering event, a free game opportunity triggering event and/or a free game progressive award triggering event occurs based on one or more promotions, for example on a certain promotional day or otherwise based on a player's patronage to a gaming establishment.

In different embodiments, a free game conversion triggering event, a free game opportunity triggering event and/or a free game progressive award triggering event occurs based on a system determination, including one or more random selections by the central controller. In one embodiment, as described above, the gaming system tracks all active electronic gaming machines and the wagers they placed. In one such embodiment, based on the electronic gaming machine's state as well as one or more wager pools associated with the electronic gaming machine, the gaming system determines whether to one or more of such events or conditions will occur. In one such embodiment, the player who consistently places a higher wager is more likely to be associated with an occurrence of one or more of such events or conditions than a player who consistently places a minimum wager. It should be appreciated that the criteria for determining whether a player is in active status or inactive status for determining if one or more of such events occur may the same as, substantially the same as, or different than the criteria for determining whether a player is in active status or inactive status for another one of such events to occur.

In different embodiments, a free game conversion triggering event, a free game opportunity triggering event and/or a free game progressive award triggering event occurs based on a determination of if any numbers allotted to an electronic gaming machine match a randomly selected number. In this embodiment, upon or prior to each play of each electronic gaming machine, an electronic gaming machine selects a random number from a range of numbers and during each primary game, the electronic gaming machine allocates the first N numbers in the range, where N is the number of credits bet by the player in that primary game. At the end of the primary game, the randomly selected number is compared with the numbers allocated to the player and if a match occurs, one or more of such events or conditions occur.

It should be appreciated that any suitable manner of causing a free game conversion triggering event, a free game opportunity triggering event and/or a free game progressive award triggering event to occur may be implemented in accordance with the gaming system and method disclosed herein.

It should be appreciated that one or more of the above-described triggers pertaining to one or more of such triggering events occurring may be combined in one or more different embodiments.

### Alternative Embodiments

It should be appreciated that in different embodiments, one or more of:
i. whether to convert a primary game award to a quantity of free games;
ii. a quantity of free games converted from a primary game award;
iii. whether to convert part or all of a primary game award to a partial primary game award;
iv. an amount of a partial primary game award provided to a player;
v. whether to convert a primary game award to a free game opportunity;
vi. one or more parameters of a free game opportunity;
vii. which free game opportunities are utilized;
viii. a probability of a player obtaining one or more free games in a free game opportunity;
ix. a quantity of free games available to be obtained in a free game opportunity;
x. whether to activate the free game conversion feature;
xi. whether to activate the free game opportunity feature;
xii. whether to contribute one or more partial primary game awards to a free game progressive award; and/or
xiii. any determination disclosed herein;
   is/are predetermined, randomly determined, randomly determined based on one or more weighted percentages, determined based on a generated symbol or symbol combination, determined independent of a generated symbol or symbol combination, determined based on a random determination by the central controller, determined independent of a random determination by the central controller, determined based on a random determination at the gaming system, determined independent of a random determination at the gaming system, determined based on at least one play of at least one game, determined independent of at least one play of at least one game, determined based on a player's selection or input, determined independent of a player's selection or input, determined based on one or more side wagers placed, determined independent of one or more side wagers placed, determined based on the player's primary game wager, determined independent of the player's primary game wager, determined based on time (such as the time of day), determined independent of time (such as the time of day), determined based on an amount of coin-in accumulated in one or more pools, determined independent of an amount of coin-in accumulated in one or more pools, determined based on a status of the player (i.e., a player tracking status), determined independent of a status of the player (i.e., a player tracking status), determined based on one or more other determinations disclosed herein, determined independent of any other determination disclosed herein or determined based on any other suitable method or criteria.

### Gaming Systems

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more electronic gaming machines (“EGMs”); and/or (c) one or more personal gaming devices, such as desktop computers, laptop computers, tablet computers or computing devices, personal digital assistants (PDAs), mobile telephones such as smart phones, and other mobile computing devices.

Thus, in various embodiments, the gaming system of the present disclosure includes: (a) one or more EGMs in combination with one or more central servers, central controllers, or remote hosts; (b) one or more personal gaming devices in combination with one or more central servers, central controllers, or remote hosts; (c) one or more personal gaming devices in combination with one or more EGMs; (d) one or more personal gaming devices, one or more EGMs, and one or more central servers, central controllers, or remote hosts in combination with one another; (e) a single EGM; (f) a plurality of EGMs in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each EGM and each personal gaming device of the present disclosure is collectively referred herein as an “EGM.” Additionally, for brevity and clarity, unless specifically stated otherwise, “EGM” as used herein represents one EGM or a plurality of EGMs, and “central server, central controller, or remote host” as used herein represents one central server, central controller, or remote host or a plurality of central servers, central controllers, or remote hosts.

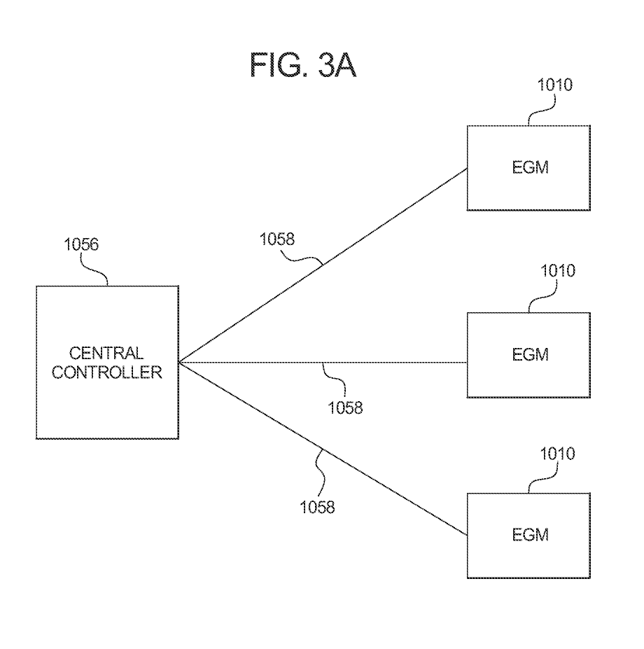

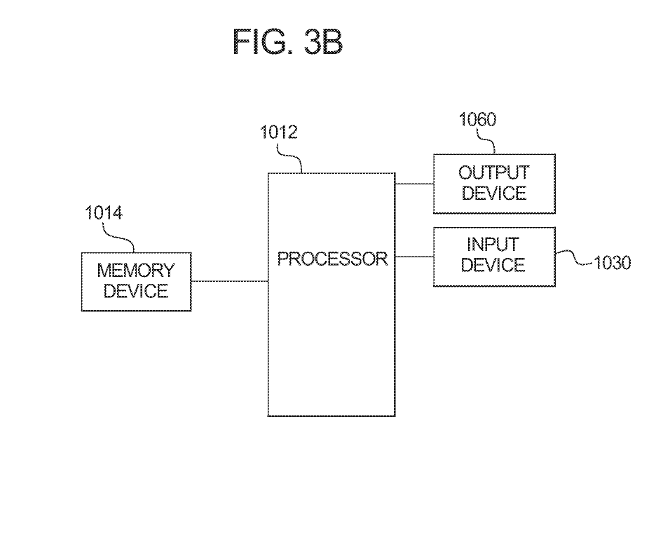

As noted above, in various embodiments, the gaming system includes an EGM in combination with a central server, central controller, or remote host. In such embodiments, the EGM is configured to communicate with the central server, central controller, or remote host through a data network or remote communication link. In certain such embodiments, the EGM is configured to communicate with another EGM through the same data network or remote communication link or through a different data network or remote communication link. For example, the gaming system illustrated in FIG. 3A includes a plurality of EGMs 1010 that are each configured to communicate with a central server, central controller, or remote host 1056 through a data network 1058.

In certain embodiments in which the gaming system includes an EGM in combination with a central server, central controller, or remote host, the central server, central controller, or remote host is any suitable computing device (such as a server) that includes at least one processor and at least one memory device or storage device. As further described herein, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host. It should be appreciated that one, more, or each of the functions of the central server, central controller, or remote host may be performed by the at least one processor of the EGM. It should be further appreciated that one, more, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs are implemented in a thin client environment, and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions for controlling any secondary or bonus games or other functions displayed by the EGM are executed by the central server, central controller, or remote host in a thin client configuration.

In certain embodiments in which the gaming system includes: (a) an EGM configured to communicate with a central server, central controller, or remote host through a data network; and/or (b) a plurality of EGMs configured to communicate with one another through a data network, the data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes: (a) an EGM configured to communicate with a central server, central controller, or remote host through a data network; and/or (b) a plurality of EGMs configured to communicate with one another through a data network, the data network is a wide area network (WAN) in which one or more of the EGMs are not necessarily located substantially proximate to another one of the EGMs and/or the central server, central controller, or remote host. For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server, central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central server, or remote host and the EGM are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

### EGM Components

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs). FIG. 3B illustrates an example EGM including a processor 1012.

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). The example EGM illustrated in FIG. 3B includes a memory device 1014. It should be appreciated that any other suitable magnetic, optical, and/or semiconductor memory may operate in conjunction with the EGM disclosed herein. In certain embodiments, the at least one processor of the EGM and the at least one memory device of the EGM both reside within a cabinet of the EGM (as described below). In other embodiments, at least one of the at least one processor of the EGM and the at least one memory device of the EGM reside outside the cabinet of the EGM (as described below).

In certain embodiments, as generally described above, the at least one memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

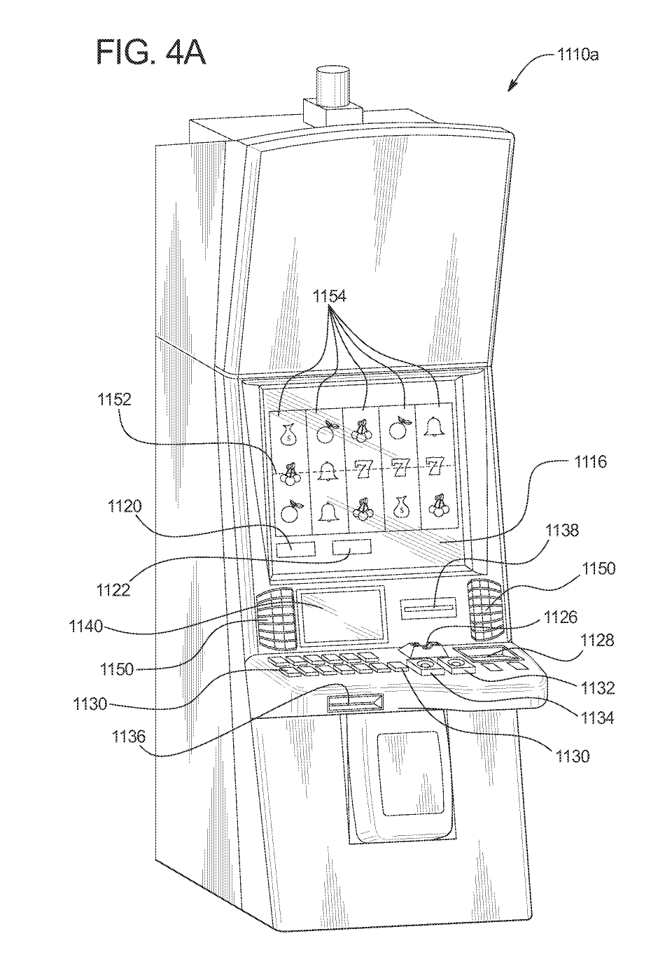

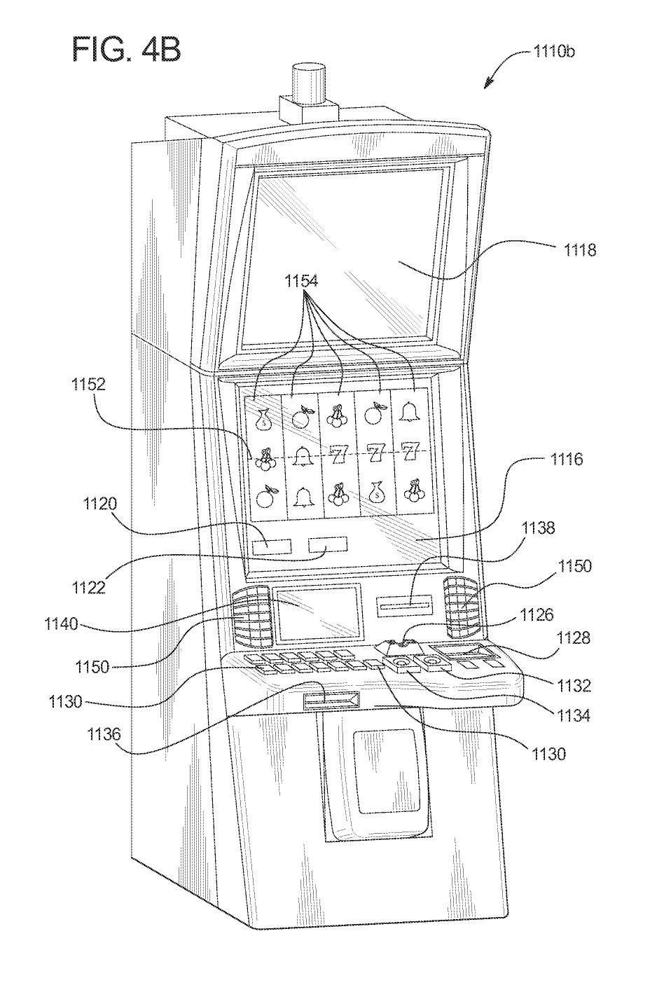

In various embodiments, the EGM includes one or more input devices. The input devices may include any suitable device that enables an input signal to be produced and received by the at least one processor of the EGM. The example EGM illustrated in FIG. 3B includes at least one input device 1030. One input device of the EGM is a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. FIGS. 4A and 4B illustrate example EGMs that each include the following payment devices: (a) a combined bill and ticket acceptor 1128, and (b) a coin slot 1126.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable wired or wireless device, to retrieve relevant information associated with that player to fund the EGM. It should be appreciated that when the EGM is funded, the at least one processor determines the amount of funds entered and displays the corresponding amount on a credit display or any other suitable display as described below.

In various embodiments, one or more input devices of the EGM are one or more game play activation devices that are each used to initiate a play of a game on the EGM or a sequence of events associated with the EGM following appropriate funding of the EGM. The example EGMs illustrated in FIGS. 4A and 4B each include a game play activation device in the form of a game play initiation button 32. It should be appreciated that, in other embodiments, the EGM begins game play automatically upon appropriate funding rather than upon utilization of the game play activation device.

In certain embodiments, one or more input devices of the EGM are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one. It should be appreciated that while the player's credit balance, the player's wager, and any awards are displayed as an amount of monetary credits or currency in the embodiments described herein, one or more of such player's credit balance, such player's wager, and any awards provided to such player may be for non-monetary credits, promotional credits, and/or player tracking points or credits.

In other embodiments, one input device of the EGM is a cash out device. The cash out device is utilized to receive a cash payment or any other suitable form of payment corresponding to a quantity of remaining credits of a credit display (as described below). The example EGMs illustrated in FIGS. 4A and 4B each include a cash out device in the form of a cash out button 1134.

In certain embodiments, one input device of the EGM is a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In various embodiments, one input device of the EGM is a sensor, such as a camera, in communication with the at least one processor of the EGM (and controlled by the at least one processor of the EGM in some embodiments) and configured to acquire an image or a video of a player using the EGM and/or an image or a video of an area surrounding the EGM.

In embodiments including a player tracking system, as further described below, one input device of the EGM is a card reader in communication with the at least one processor of the EGM. The example EGMs illustrated in FIGS. 4A and 4B each include a card reader 1138. The card reader is configured to read a player identification card inserted into the card reader.

In various embodiments, the EGM includes one or more output devices. The example EGM illustrated in FIG. 3B includes at least one output device 1060. One or more output devices of the EGM are one or more display devices configured to display any game(s) displayed by the EGM and any suitable information associated with such game(s). In certain embodiments, the display devices are connected to or mounted on a cabinet of the EGM (as described below). In various embodiments, the display devices serves as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM illustrated in FIG. 4A includes a central display device 1116, a player tracking display 1140, a credit display 1120, and a bet display 1122. The example EGM illustrated in FIG. 4B includes a central display device 1116, an upper display device 1118, a player tracking display 1140, a player tracking display 1140, a credit display 1120, and a bet display 1122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the EGM is a payout device. In these embodiments, when the cash out device is utilized as described above, the payout device causes a payout to be provided to the player. In one embodiment, the payout device is one or more of: (a) a ticket generator configured to generate and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example EGMs illustrated in FIGS. 4A and 4B each include ticket generator 1136. In one embodiment, the EGM includes a payout device configured to fund an electronically recordable identification card or smart card or a bank account via an electronic funds transfer.

In certain embodiments, one output device of the EGM is a sound generating device controlled by one or more sound cards. In one such embodiment, the sound generating device includes one or more speakers or other sound generating hardware and/or software for generating sounds, such as by playing music for any games or by playing music for other modes of the EGM, such as an attract mode. The example EGMs illustrated in FIGS. 4A and 4B each include a plurality of speakers 1150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels. SCSI ports, solenoids, speakers, thumbsticks, ticket readers, touch screens, trackballs, touchpads, wheels, and wireless communication devices. At least U.S. Patent Application Publication No. 2004/0254014 describes a variety of EGMs including one or more communication ports that enable the EGMs to communicate and operate with one or more external peripherals.

As generally described above, in certain embodiments, such as the example EGMs illustrated in FIGS. 4A and 4B, the EGM has a support structure, housing, or cabinet that provides support for a plurality of the input device and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs shown in FIGS. 4A and 4B, EGMs may have varying cabinet and display configurations.

It should be appreciated that, in certain embodiments, the EGM is a device that has obtained approval from a regulatory gaming commission, and in other embodiments, the EGM is a device that has not obtained approval from a regulatory gaming commission.

As explained above, for brevity and clarity, both the EGMs and the personal gaming devices of the present disclosure are collectively referred to herein as “EGMs.” Accordingly, it should be appreciated that certain of the example EGMs described above include certain elements that may not be included in all EGMs. For example, the payment device of a personal gaming device such as a mobile telephone may not include a coin acceptor, while in certain instances the payment device of an EGM located in a gaming establishment may include a coin acceptor.

### Operation of Primary or Base Games and/or Secondary or Bonus Games

In various embodiments, an EGM may be implemented in one of a variety of different configurations. In various embodiments, the EGM may be implemented as one of: (a) a dedicated EGM wherein computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM wherein computerized game programs executable by the EGM for controlling any primary games and/or secondary games displayed by the EGM are downloadable to the EGM through a data network or remote communication link after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award. At least U.S. Pat. Nos. 7,470,183; 7,563,163; and 7,833,092 and U.S. Patent Application Publication Nos. 2005/0148382, 2006/0094509, and 2009/0181743 describe various examples of this type of award determination.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos. 7,753,774; 7,731,581; 7,955,170; and 8,070,579 and U.S. Patent Application Publication No. 2011/0028201 describe various examples of this type of award determination.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database for storing player profiles, (b) a player tracking module for tracking players (as described below), and (c) a credit system for providing automated transactions. At least U.S. Pat. No. 6,913,534 and U.S. Patent Application Publication No. 2006/0281561 describe various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGMs shown in FIGS. 4A and 4B each include a payline 1152 and a plurality of reels 1156. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display positions on a requisite number of adjacent reels. In one such embodiment, one or more paylines are formed between at least two symbol display positions that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display positions, the gaming system enables a wager to be placed on a plurality of symbol display positions, which activates those symbol display positions.

In various embodiments, the gaming system provides one or more awards after a spin of the reels when specified types and/or configurations of the indicia or symbols on the reels occur on an active payline or otherwise occur in a winning patter, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display positions on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No. 8,012,011 and U.S. Patent Application Publication Nos. 2008/0108408 and 2008/0132320 describe various examples of ways to win award determinations.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award. At least U.S. Pat. Nos. 5,766,079; 7,585,223; 7,651,392; 7,666,093; 7,780,523; and 7,905,778 and U.S. Patent Application Publication Nos. 2008/0020846, 2009/0123364, 2009/0123363, and 2010/0227677 describe various examples of different progressive gaming systems.

As generally noted above, in addition to providing winning credits or other awards for one or more plays of the primary game(s), in various embodiments the gaming system provides credits or other awards for one or more plays of one or more secondary games. The secondary game typically enables a prize or payout in to be obtained addition to any prize or payout obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, altematively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards. At least U.S. Patent Application Publication Nos. 2007/0123341, 2008/0070680, 2008/0176650, and 2009/0124363 describe various examples of different group gaming systems.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311.605; 7,611,411; 7,617,151; and 8,057,298 describe various examples of player tracking systems.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one display device;
at least one input device;
at least one processor; and
at least one memory device which stores a plurality of instructions, which when executed by the at least one processor, cause the at least one processor to operate with the at least one display device and the at least one input device to:
(a) receive a wager in association with a play of a primary game,
(b) for the wagered on play of the primary game:
(i) determine a primary game outcome,
(ii) display the determined primary game outcome,
(iii) determine a primary game award amount associated with the determined primary game outcome, and
(iv) display the determined primary game award, and
(c) if the determined primary game award amount is at least a designated amount:
(i) determine whether to convert at least part of the determined primary game award amount to at least one free game, said determination being based, at least in part, on the determined primary game award amount and an average expected value of a free game,
(ii) if the determination is convert at least part of the determined primary game award amount to at least one free game, for each free game:
(A) determine a free game outcome,
(B) display the determined free game outcome,
(C) determine any free game award associated with the determined free game outcome, and
(D) display any determined free game award, and
(iii) if the determination is not to convert at least part of the determined primary game award amount to at least one free game, display a free game opportunity, wherein a probability of obtaining at least one free game in the free game opportunity is based, at least in part, on the determined primary game award amount and the average expected value of the free game.

2. The gaming system of claim 1, wherein when executed by the at least one processor, the plurality of instructions cause the at least one processor to:
determine, based at least in part on the determined primary game award amount, a partial primary game award amount, and
display any determined partial primary game award amount.

3. The gaming system of claim 2, wherein said determination whether to convert at least part of the determined primary game award amount to at least one free game is based, at least in part, on the determined primary game award amount, the average expected value of the free game and the determined partial primary game award amount.

4. The gaming system of claim 2, wherein when executed by the at least one processor if the determination is not to convert at least part of the determined primary game award amount to at least one free game, the plurality of instructions cause the at least one processor to determine the probability of obtaining at least one free game in the free game opportunity based, at least in part, on the determined primary game award amount, the average expected value of the free game and the determined partial primary game award amount.

5. The gaming system of claim 2, wherein when executed by the at least one processor, the plurality of instructions cause the at least one processor to contribute the determined partial primary game award amount to a free game progressive award.

6. The gaming system of claim 1, wherein when executed by the at least one processor if the determination is not to convert at least part of the determined primary game award amount to at least one free game, the plurality of instructions cause the at least one processor to determine, based on the probability of obtaining at least one free game in the free game opportunity, a quantity of free games in association with the free game opportunity.

7. The gaming system of claim 6, wherein when executed by the at least one processor if the determined quantity of free games is at least one, the plurality of instructions cause the at least one processor to, for each of the quantity of free games:
(i) determine a free game outcome,
(ii) display the determined free game outcome,
(iii) determine any free game award associated with the determined free game outcome, and
(iv) display any determined free game award,

8. The gaming system of claim 1, wherein when executed by the at least one processor, the plurality of instructions cause the at least one processor to determine whether to convert at least part of each of a plurality of primary game award amounts to at least one free game, said determination being based, at least in part, on a total of the primary game award amounts and the average expected value of the free game.

9. The gaming system of claim 1, wherein at least one of the wager, the determined primary game award amount and any free game award include at least one selected from the group consisting of: a quantity of monetary credits, a quantity of non-monetary credits, a quantity of promotional credits, a quantity of player tracking points, a quantity of free plays of a game, and a quantity of plays of at least one non-wagering game.

10. A gaming system server comprising:
at least one processor; and
at least one memory device which stores a plurality of instructions, which when executed by the at least one processor, cause the at least one processor to:
(a) receive data representing a wager placed in association with a play of a primary game,
(b) for the wagered on play of the primary game:
(i) determine a primary game outcome,
(ii) cause at least one display device to display the determined primary game outcome,
(iii) determine a primary game award amount associated with the determined primary game outcome, and
(iv) cause the at least one display device to display the determined primary game award amount, and
(c) if the determined primary game award amount is at least a designated amount:
(i) determine whether to convert at least part of the determined primary game award amount to at least one free game, said determination being based, at least in part, on the determined primary game award amount and an average expected value of a free game,
(ii) if the determination is convert at least part of the determined primary game award amount to at least one free game, for each free game:
(A) determine a free game outcome,
(B) cause the at least one display device to display the determined free game outcome,
(C) determine any free game award associated with the determined free game outcome, and
(D) cause the at least one display device to display any determined free game award, and
(iii) if the determination is not to convert at least part of the determined primary game award amount to at least one free game, cause the at least one display device to display a free game opportunity, wherein a probability of obtaining at least one free game in the free game opportunity is based, at least in part, on the determined primary game award amount and the average expected value of the free game.

11. The gaming system server of claim 10, wherein when executed by the at least one processor, the plurality of instructions cause the at least one processor to:
determine, based at least in part on the determined primary game award amount, a partial primary game award amount, and
display any determined partial primary game award amount.

12. The gaming system server of claim 11, wherein said determination whether to convert at least part of the determined primary game award amount to at least one free game is based, at least in part, on the determined primary game award amount, the average expected value of the free game and the determined partial primary game award amount.

13. The gaming system server of claim 11, wherein when executed by the at least one processor if the determination is not to convert at least part of the determined primary game award amount to at least one free game, the plurality of instructions cause the at least one processor to determine the probability of obtaining at least one free game in the free game opportunity based, at least in part, on the determined primary game award amount, the average expected value of the free game and the determined partial primary game award amount.

14. The gaming system server of claim 11, wherein when executed by the at least one processor, the plurality of instructions cause the at least one processor to contribute the determined partial primary game award amount to a free game progressive award.

15. The gaming system server of claim 10, wherein when executed by the at least one processor if the determination is not to convert at least part of the determined primary game award amount to at least one free game, the plurality of instructions cause the at least one processor to determine, based on the probability of obtaining at least one free game in the free game opportunity, a quantity of free games in association with the free game opportunity.

16. The gaming system server of claim 15, wherein when executed by the at least one processor if the determined quantity of free games is at least one, the plurality of instructions cause the at least one processor to, for each of the quantity of free games:
(i) determine a free game outcome,
(ii) cause the at least one display device to display the determined free game outcome,
(iii) determine any free game award associated with the determined free game outcome, and
(iv) cause the at least one display device to display any determined free game award,

17. The gaming system server of claim 10, wherein when executed by the at least one processor, the plurality of instructions cause the at least one processor to determine whether to convert at least part of each of a plurality of primary game award amounts to at least one free game, said determination being based, at least in part, on a total of the primary game award amounts and the average expected value of the free game.

18. The gaming system server of claim 10, wherein at least one of the wager, the determined primary game award amount and any free game award include at least one selected from the group consisting of: a quantity of monetary credits, a quantity of non-monetary credits, a quantity of promotional credits, a quantity of player tracking points, a quantity of free plays of a game, and a quantity of plays of at least one non-wagering game.

19. The gaming system server of claim 10, which transmits and receives data over a data network.

20. The gaming system server of claim 19, wherein the data network is an internet.
